(19) United States
(12) Patent Application Publication
(10) Pub. No.: US 2024/0416728 A1
(43) Pub. Date: Dec. 19, 2024

(54) ARRANGEMENT WITH TRANSPARENT PANEL HEATER

(71) Applicant: Webasto SE, Stockdorf (DE)

(72) Inventors: Philip ERTLE, Stockdorf (DE); Georg ROSSMAIR, Stockdorf (DE)

(21) Appl. No.: 18/740,184

(22) Filed: Jun. 11, 2024

(30) Foreign Application Priority Data
Jun. 14, 2023 (DE) 102023115478.8

(51) Int. Cl. B60J 1/00; B60J 1/08; B60J 1/20

(52) U.S. Cl. CPC B60J 1/001; B60J 1/08; B60J 1/2013

(57) ABSTRACT

An arrangement for a vehicle has first, second and third pane elements. The first pane element has a first main surface and a second main surface that lies opposite the first main surface along a stack direction. The second pane element has a third main surface and a fourth main surface that lies opposite the third main surface along the stack direction, the second pane element being coupled with the first pane element. The third pane element has a fifth main surface and a sixth main surface that lies opposite the fifth main surface along the stack direction, a pane gap being arranged between the second pane element and the third pane element, and the third pane element being thermally decoupled from the second pane element. A heating layer is coupled with the third pane element and is configured to increase the temperature in the vehicle interior.

### CROSS-REFERENCE TO RELATED APPLICATION(S)

This application claims the benefit of German Patent Application No. 102023115478.8 filed Jun. 14, 2023, which is incorporated herein by reference in its entirety.

### TECHNICAL FIELD

The present invention relates to an arrangement which comprises a heating layer. The present invention further relates to a vehicle with such an arrangement.

### BACKGROUND

Vehicles have panel heaters at various locations. They are applied in nontransparent surfaces, for example in the side trim.

### SUMMARY

It is desirable to provide an arrangement, in particular for a vehicle pane, which increases the comfort in a vehicle interior. In particular, the arrangement is provided in a vehicle roof, a windshield, a rear window, and/or a side window.

According to one embodiment, an arrangement for a vehicle has:
a first pane element, which has a first main surface and has a second main surface that lies opposite the first main surface along a stack direction,
a second pane element, which has a third main surface and has a fourth main surface that lies opposite the third main surface along the stack direction, the second pane element being coupled with the first pane element,
a third pane element, which has a fifth main surface and has a sixth main surface that lies opposite the fifth main surface along the stack direction, a pane gap being arranged between the second pane element and the third pane element, and the third pane element being thermally decoupled from the second pane element,
a heating layer, which is coupled with the third pane element and which is configured to increase the temperature in the vehicle interior.

The first, second, third, fourth, fifth and sixth main surfaces each have a larger extent than side surfaces, aligned transversely thereto, of the first, second and third pane elements. The first pane element extends flat and has a significantly greater extent along the first and second main surfaces than transversely thereto. The second pane element extends flat and has a significantly greater extent along the third and fourth main surfaces than transversely thereto. The third pane element extends flat and has a significantly greater extent along the fifth and sixth main surfaces than transversely thereto. The first and second pane elements are arranged according to the stack direction in such a way that the third main surface and the second main surface are aligned with respect to one another. Furthermore, the second and third pane elements are arranged according to the stack direction in such a way that the fourth and fifth main surfaces are aligned oriented with respect to one another.

The first and second pane elements are coupled, and may also be referred to together as an outer pane of the vehicle.

The pane gap between the second and third pane elements firstly allows thermal decoupling between the second and third pane elements. During use of the arrangement on the vehicle, the third pane element forms the pane element that is assigned to an interior of the vehicle, and may be referred to as an inner pane of the vehicle. The inner pane may be formed as a single pane or as a laminated pane with at least two panes. The thermal decoupling offers advantages for summer and winter thermal protection. In summer, the inner pane is not heated so greatly and is therefore felt to be pleasantly cooler. In winter, the inner pane remains at a higher temperature even when driving, and is felt to be more pleasant.

This is associated with more efficient cooling and more efficient heating in summer or in winter, respectively, which saves on energy and therefore costs for running the vehicle.

In this context, thermal decoupling means that heat exchange between the second and third pane elements is at least reduced. The heat exchange is caused by the following mechanisms: conduction, convection and thermal radiation.

The heating layer is a transparent electrically conductive layer. The heating layer may be operated with the same feeling of comfort at relatively low room temperatures, since the thermal radiation is essentially felt to be pleasant. The heat losses through the enclosing space, for example through the body or the glass elements, are reduced by the lower room air temperatures. In winter, for example, panes are constantly cooled from the outside by airflow, in particular when driving. By the combination of the thermal decoupling and the heating layer, which is applied on the third pane element, the external environment is not also heated, so that even more energy is saved when running the vehicle. The inner pane is therefore thermally regulated pleasantly, so that the wellbeing of the vehicle occupants is increased.

In summer, on the other hand, the inner pane is not heated so strongly because of the thermal decoupling, and is therefore pleasantly felt to be cooler. Such an arrangement avoids the glass being heated above 80° C. in direct sunlight and occasionally causing burns by accidental touching, for example on the skin of the hand or in the head region of individuals.

Alternatively, the heating layer is fitted in a pane laminate or on the upper and/or lower side of the pane laminate. Furthermore, the heating layer is applied for example in segments and not as a surface-wide layer. In this embodiment, this segmented heating layer is transparent and/or nontransparent.

According to at least one embodiment, the arrangement has an electrically conductive layer, for example a metal layer. Alternatively, the arrangement has for example nanotubes, graphite and/or indium tin oxide (ITO) as an electrically conductive layer. The electrically conductive layer is applied on the fourth main surface of the second pane element. Instead of a flat layer, a grid structure or line structure is alternatively possible.

The metal layer may for example be configured as a wavelength-selective coating with a low emissivity (low-E). The low-E layer is as transparent as possible for the incident sunlight, so as to obtain a high overall energy transmittance and no shifts of the visible light spectrum. For example, layers of silver, copper, gold or tin oxide are used as the material for the low-E layer. In order to increase the transmission and durability of the low-E layer, the silver coating is for example embedded in oxide layers. The low-E layer reduces the heat loss due to thermal radiation, so that even more energy is saved when running the vehicle. At the same time, the thermal management can be improved by effective low-E layers. The low-E layer reflects the energy of the heating layer in the direction of the inner pane and, in particular, ensures that the energy is not dissipated through the outer pane. Alternatively, the low-E layer is imparted to the fifth main surface. If the low-E layer is for example imparted to the fifth main surface, in winter it reduces the heat loss outward and in summer it reduces the thermal input inward. At the same time, it may be used as a conductive and/or heating layer.

According to at least one embodiment, the arrangement has a shading device. The shading device is arranged between the first and third pane elements and makes it possible to darken the vehicle interior. Alternatively, the shading device is configured below the third pane element.

The shading device makes it possible to shield direct sunlight, so that the vehicle interior is heated less. This effect is further reinforced in combination with the thermally decoupled inner pane. Even if the first pane element and/or the second pane element is heated, less heat is radiated into the vehicle interior.

According to at least one embodiment, the shading device is arranged between the second and third pane elements and comprises a switchable film.

The switchable film is formed for example from a suspended particle composition (suspended particle device, SPD) and/or an electrochromic layer (EC) and/or a liquid crystal (LC) or polymer-dispersed liquid crystals (PDLC), or comprises such a material.

Furthermore, the switchable film is embedded in a layer which, for example, is made of polyvinyl butyral (PVB) and/or ethylene vinyl acetate (EVA) and/or thermoplastic polyolefin (TPO) and/or polyolefin (PO) and/or thermoplastic polyurethane (TPU), or comprises such a material.

The switchable film therefore provides a convenient shading function.

Furthermore, the electrode of such a film may also be formed as a heating layer.

Furthermore, for example, polyvinyl butyral (PVB) reinforces the coupling between the first pane element and the second pane element. The two pane elements therefore form a monolithic structure. In physical terms, the two pane elements are therefore one pane, which plays a part for forces that act for example during movements in operation. Mutual displacement of the first and second pane elements is therefore prevented.

According to one embodiment, the shading device is arranged between the second and third pane elements and comprises a roller blind apparatus.

A roller blind apparatus straightforwardly makes it possible to darken the vehicle interior and reduce the thermal input due to sunlight. This provides a further advantage by increasing the energy efficiency.

According to one embodiment, the pane gap is filled with an insulating gas.

Spacers may be used in the pane gap for stabilization against the external pressure. For example, so-called spacer bands are used, which comprise a drying agent, vapour barrier and spacer. The use of an insulating gas in the pane gap advantageously reduces the heat loss by conduction and convection. The heat loss is lower with an insulating gas than with normal air. In addition, the insulating gas in the pane gap acts to reduce noise, which increases the comfort in the vehicle interior.

According to one embodiment, the pane gap is evacuated.

Spacers may be used in the pane gap for stabilization against the external pressure, since a reduced pressure prevails in evacuated spaces. In non-evacuated pane gaps, the pressure in the pane gap is increased by sunlight. The stresses acting on the pane, and therefore also the risk of damage to the panes, increase with the pressure. The pressure increase is substantially prevented by using the evacuated pane gap. The evacuated pane gap also reduces the heat loss by conduction and convection, since there is no air layer or gas layer. Furthermore, the vacuum in the pane gap acts to reduce noise, which increases the comfort in the vehicle interior even more.

The pane gap has the further advantage that interfering reflections on the inner pane are reduced. Since the thermal management is primarily carried out by the thermal separation between the panes, a reflective low-E layer on the inner side may therefore be obviated. This ensures better driving safety and more pleasant transport for the vehicle occupants.

According to one embodiment, the heating layer is formed as a film layer and/or is vapour-deposited.

The heating layer may, for example be integrated into a film which is made from polyvinyl butyral (PVB) and/or polyethylene terephthalate (PET), or which comprises such a material. PVB is distinguished by its splinter-binding effect and high tearing strength. This has the advantage that the heating layer may be used as additional splinter protection.

The heating layer may be applied by means of conventional methods. These include vacuum-based coating methods such as physical vapour deposition, for example thermal evaporation, electron-beam evaporation and other methods.

According to one embodiment, the heating layer is applied on the fifth and/or sixth main surface of the third pane element.

Applying the heating layer on the sixth main surface allows more rapid heating of the inner pane on the side facing toward the vehicle interior, which improves comfort.

In addition, using the heating layer in the form of a film layer advantageously allows splinter protection in relation to the third pane element. The vehicle interior is therefore protected in the event of damage to the third pane element.

By arranging the heating layer on the fifth main surface of the third pane element, the heating layer is encapsulated and better protected against external influences.

In the case of a vapour-deposited and/or printed heating layer, the heating layer may also advantageously be used as a spacer in the pane gap.

Furthermore, in the case of an evacuated pane gap, the heating layer is protected against possible corrosion.

According to one embodiment, the third pane element is a plate-shaped light guide element. The light guide element is coupled with a light source and is adapted to guide light fed in by the light source and to provide it for predetermined illumination of the vehicle interior.

By using the pane gap as a medium adjacent to the plate-shaped light guide element, the total internal reflection that is necessary for efficient illumination is improved. The lower refractive index of the medium inside the pane gap in relation to air allows larger angles of the light rays with respect to the interface layer.

A larger angle with respect to the interface layer leads to a higher light intensity since a light ray inside the light guide element is reflected more often over a predetermined distance.

According to at least one embodiment, a vehicle is provided, which has an arrangement according to one of the embodiments described here, at least one vehicle opening, and a closure element. The closure element has the arrangement and is configured to close the vehicle opening

The arrangement is for example a windshield. Alternatively or in addition, the arrangement is for example a sunroof. Alternatively or in addition, the arrangement is for example a side window. Alternatively or in addition, the arrangement is for example a rear window.

The vehicle is for example a motor vehicle, for example an automobile or truck. Means of public transport, such as buses or trains, are likewise included.

### BRIEF DESCRIPTION OF DRAWINGS

Exemplary embodiments of the disclosure are explained in more detail below with the aid of the schematic drawings, in which:

FIG. 1 shows a schematic representation of a part of a vehicle according to one exemplary embodiment,

FIGS. 2 to 7 respectively show schematic representations of an arrangement according to exemplary embodiments.

### DETAILED DESCRIPTION

Elements that have the same design and function are denoted by the same references throughout the figures.

In this description, terms such as “up”, “down”, “upper side”, “lower side”, “inner” and “outer”, “front” and “rear” refer to alignments and orientations as they are illustrated in the figures and are conventional in a motor vehicle ready for operation.

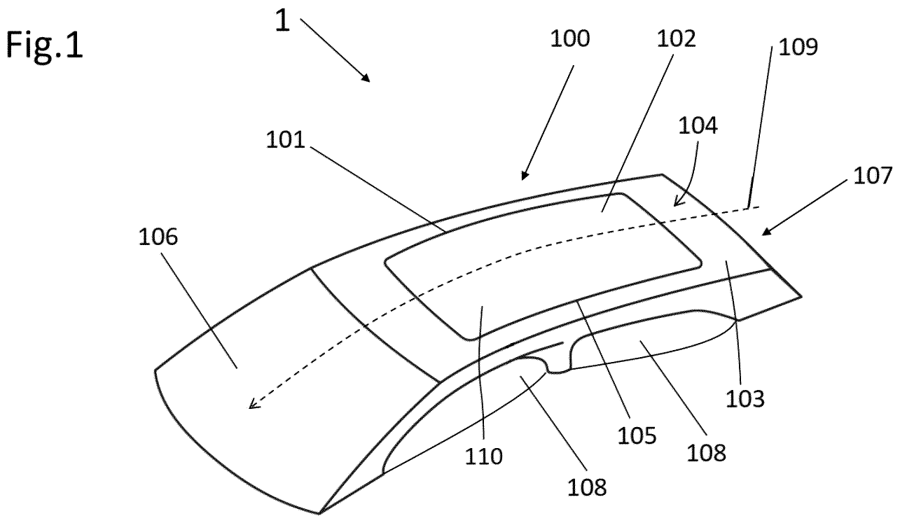

FIG. 1 shows an arrangement 1 for a vehicle 100, which forms a closure element 102 in the vehicle 100 that is configured to close a vehicle opening 101 in the vehicle 100.

The closure element 102 is formed for example as a cover 104 in a vehicle roof 103, which is configured to close for example a roof opening 105 in the vehicle roof 103. The arrangement 1 may form a part or portion of the cover 104, for example as a sunroof 110, or alternatively it forms the latter fully. The closure element 102 is configured for example as a glass cover. Furthermore, the arrangement 1 may for example form a part or portion of a windshield 106, of a rear window 107 or of a side window 108, or alternatively it may form the latter fully.

A vehicle longitudinal direction 109 extends from the rear window 107 to the windshield 106.

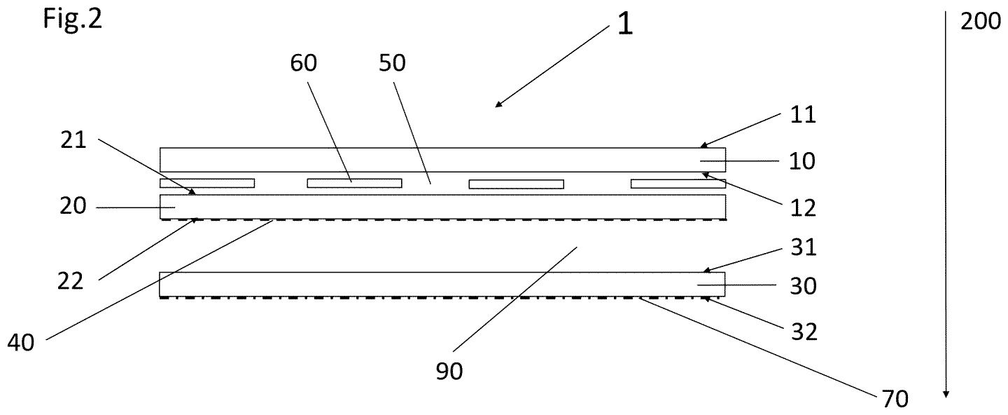

FIG. 2 shows an exemplary embodiment of the arrangement 1 in a schematic side view. Along a stack direction 200, the arrangement 1 initially has a first pane element 10. In the state ready for operation, the first pane element 10 faces outward and is arranged facing away from an interior of the vehicle 100. The first pane element 10 has a first main surface 11 and a second main surface 12 arranged opposite. In the state ready for operation, the first main surface 11 faces outward. In the state ready for operation, the second main surface 12 faces toward the interior of the vehicle 100. In particular, the second main surface 12 is arranged opposite the first main surface 11 along the stack direction 200. The arrangement 1 has a second pane element 20. The second pane element 20 has a third main surface 21 and a fourth main surface 22. The third main surface 21 faces toward the first pane element 10. The fourth main surface 22 is arranged opposite the third main surface 21 along the stack direction 200. The first pane element 10 and the second pane element 20 are arranged according to the stack direction 200 in such a way that the third main surface 21 and the second main surface 12 are aligned with one another.

The arrangement 1 has a third pane element 30. The third pane element has a fifth main surface 31 and a sixth main surface 32. The fifth main surface 31 faces toward the second pane element 20. The sixth main surface 32 is arranged opposite the fifth main surface 31 along the stack direction 200. In the state ready for operation, the third pane element 20 faces toward the interior of the vehicle 100. Furthermore, the second pane element 20 and the third pane element 30 are arranged according to the stack direction 200 in such a way that the fourth main surface 22 and the fifth main surface 31 are aligned oriented with one another.

The six main surfaces 11, 12, 21, 22, 31, 32 are directed in the same way and are arranged at a distance from one another. The six main surfaces 11, 12, 21, 22, 31, 32 are in particular arranged parallel to one another within the scope of conventional tolerances.

The first pane element 10, the second pane element 20 and the third pane element 30 are in particular clear glass panes. The pane elements 10, 20, 30 may alternatively or in addition be tinted. Alternatively or in addition, panes of polycarbonate and/or polymethyl methacrylate (PMMA) are used.

The first pane element 10 and the second pane element 20 are connected to one another by means of a plastic layer 50. The plastic layer 50 is, for example, a layer of polyvinyl butyral (PVB). The plastic layer 50 is used as a hot-melt adhesive layer in order to connect the first pane element 10 and the second pane element 20 to one another. Along the stack direction 200, the first pane element 10 is therefore arranged first, followed by the plastic layer 50 and in turn followed by the second pane element 20. A switchable film 60 is embedded in the plastic layer 50. The switchable film 60 is, for example, formed from a suspended particle composition (suspended particle device, SPD) and/or a liquid crystal (LC) or polymer-dispersed liquid crystals (PDLC), or comprises such a material. The switchable film 60 therefore constitutes a shading apparatus 60, which offers the possibility of darkening the vehicle interior conveniently and/or modifying the light transmission through the arrangement 1, for example by higher light scattering.

The first pane element 10 and the second pane element 20 may also be referred to together as the outer pane. The first and second pane elements 10, 20 therefore form a monolithic pane without thermal decoupling. In physical terms, the two pane elements 10, 20 are therefore one pane, which plays a part for forces that act for example during movements.

The metal layer 40 is applied on the fourth main surface 22 of the second pane element 20. The metal layer 40 is configured for example as a wavelength-selective coating with a low emissivity (low-E). The low-E layer is as transparent as possible. The low-E layer reduces the heat loss due to thermal radiation.

If the low-E layer is imparted for example to the fifth main surface 31, in winter it reduces the heat loss outward and in summer it reduces the thermal input inward. At the same time, it may be used as a conductive and/or heating layer.

Arranged after the second pane element 20, there is a pane gap 90, in turn followed by the third pane element 30, which may also be referred to as the inner pane.

The pane gap 90 is evacuated or filled with an insulating gas or with air. By the thermal decoupling, the pane gap 90 filled with an insulating gas or air advantageously reduces the heat loss by conduction. The heat loss is lower with an insulating gas than with normal air.

The evacuated pane gap 90 also reduces the heat loss by conduction even further, since there is no air layer or gas layer that allows heat exchange by conduction. Furthermore, the insulating gas and the vacuum in the pane gap 90 act to reduce noise, which increases the comfort in the vehicle interior even more.

The pane gap 90 has the further advantage that interfering reflections on the inner pane are reduced. On the one hand, the distance from the inner pane to the metal layer 40 ensures lower reflection. On the other hand, a suitable choice of the medium in the pane gap 90 allows advantageous refraction and reflection of incident light at the interface layer between the third pane element 30 and the pane gap 90. This ensures greater driving safety and more pleasant transport for the vehicle occupants.

The heating layer 70 is in the present case on the sixth main surface 32 of the third pane element 30, coupled with the latter. The heating layer 70 is configured as a film or may be vapour-deposited and/or printed. Applying the heating layer 70 on the sixth main surface 32 allows more rapid heating of the inner pane on the side facing toward the vehicle interior, which improves comfort.

The heating layer 70 also ensures that the temperature in the vehicle interior is felt to be more pleasant, since the thermal radiation thermal radiation is felt to be pleasant.

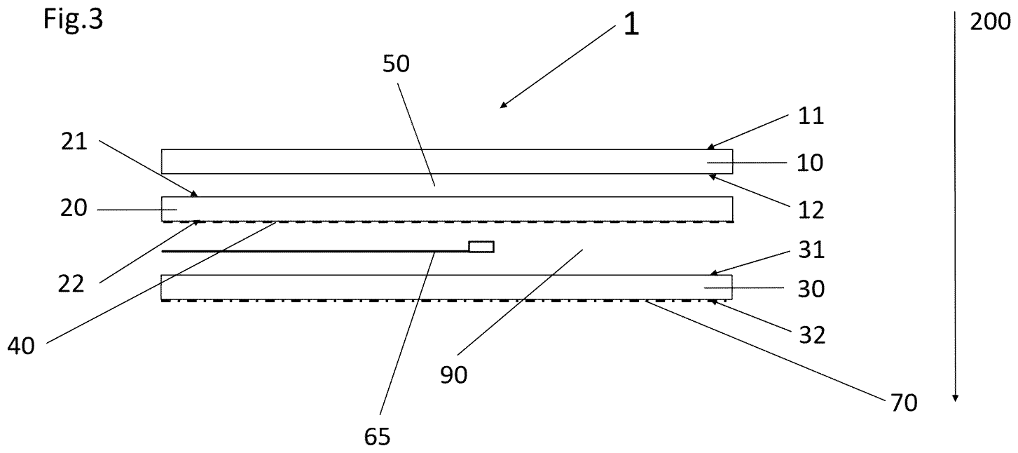

FIG. 3 shows a further exemplary embodiment of the arrangement 1 in a schematic side view. The arrangement 1 is the same as in FIG. 2, with the difference that a roller blind apparatus 65 instead of the switchable film 60 is used as a shading device 65.

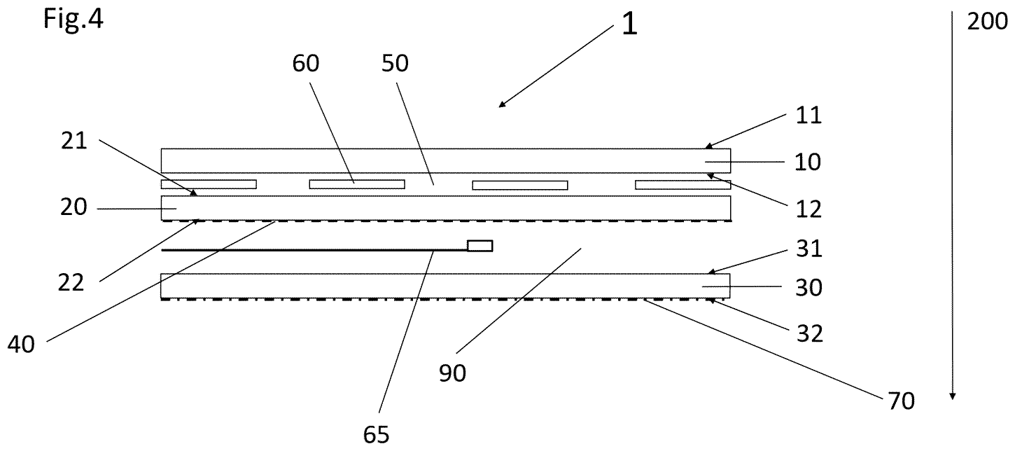

FIG. 4 shows a further exemplary embodiment of the arrangement 1 in a schematic side view. The arrangement 1 is the same as in FIG. 3, with the difference that both the switchable film 60 and the roller blind apparatus 65 are used as a shading device 60, 65.

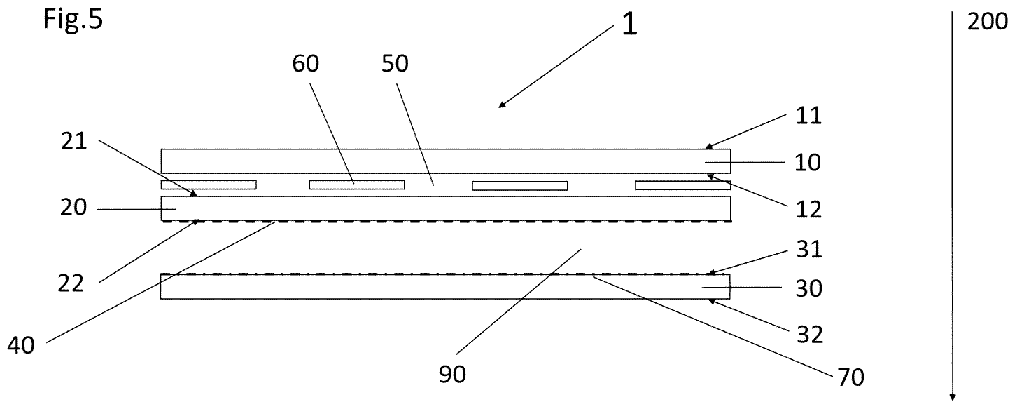

FIG. 5 shows a further exemplary embodiment of the arrangement 1 in a schematic side view. The arrangement 1 is the same as in FIG. 2, with the difference that the heating layer 70 is applied on the fifth main surface 31. By arranging the heating layer 70 on the fifth main surface 31 of the third pane element 30, the heating layer 70 is encapsulated and is better protected against external influences. The heating layer 70 is configured for example as a low-E layer and offers the advantage that the heat loss by thermal radiation is reduced, and at the same time the heating layer 70 can be used for heating with low heat losses.

In the case of a vapour-deposited and/or printed heating layer 70, the heating layer 70 may also advantageously be used as a spacer in the pane gap 90, so that the heating layer 70 acts against the pressure from the outside. Furthermore, in the case of an evacuated pane gap 90, the heating layer 70 is protected against possible corrosion.

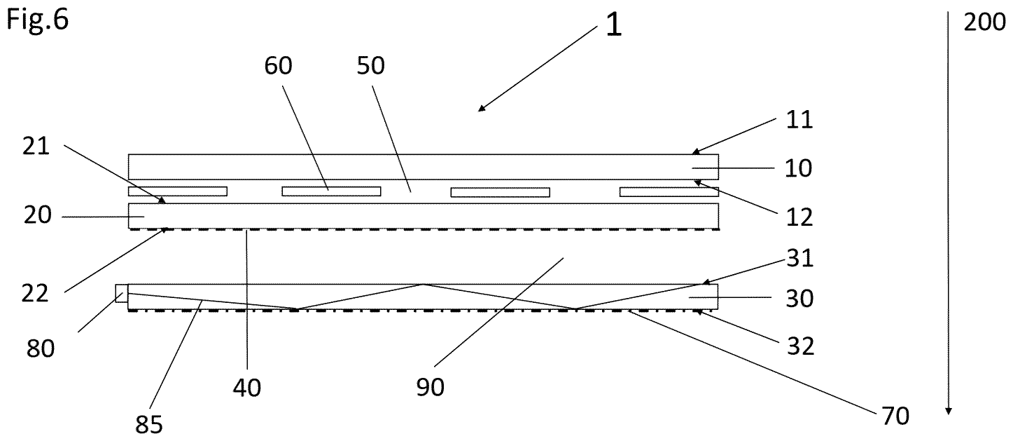

FIG. 6 shows a further exemplary embodiment of the arrangement 1 in a schematic side view. The arrangement 1 is the same as in FIG. 2, with the difference that the third pane element 30 is used as a plate-shaped light guide element 35. For example, white glass is used as the light guide element 35. The light guide element 35 is coupled with a light source 80. The light guide element 35 can guide light fed in by the light source 80, represented in FIG. 6 by way of example with the aid of a single light ray 85. This ensures predetermined illumination of the vehicle interior.

The heating layer 70 may be applied on the fifth main surface 31 or on the sixth main surface 32 of the third pane element 30.

In an alternative embodiment, the second pane element 20 is used as a light guide element 35, which is coupled with a light source 80.

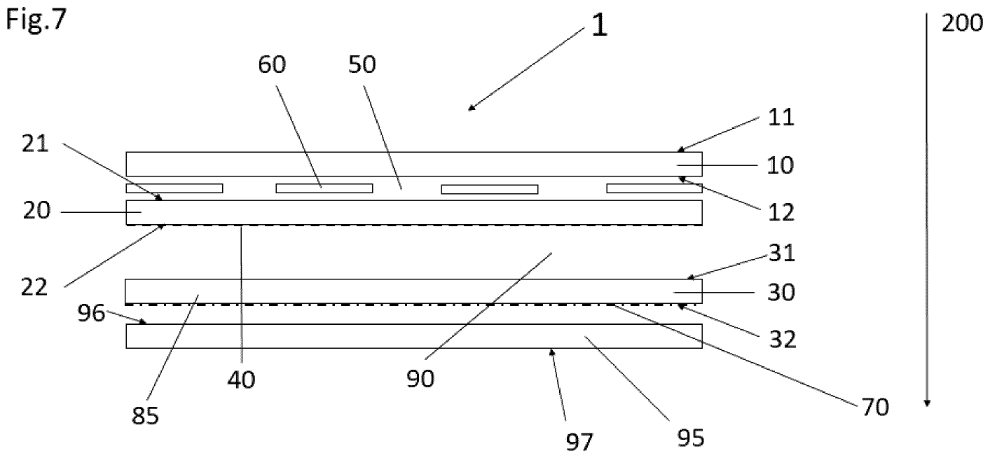

FIG. 7 shows a further exemplary embodiment of the arrangement 1 in a schematic side view. The arrangement 1 is the same as in FIG. 2, with the difference that a fourth pane element 95 with a seventh main surface 96 and an eighth main surface 97 is used.

The seventh main surface 96 faces toward the third pane element 30. The eighth main surface 97 is arranged opposite the seventh main surface 96 along the stack direction 200. In the state ready for operation, the fourth pane element 95 faces toward the interior of the vehicle 100. Furthermore, the third pane element 30 and the fourth pane element 95 are arranged according to the stack direction 200 in such a way that the sixth main surface 32 and the seventh main surface 96 are aligned oriented with one another.

The seventh main surface 96 and the eighth main surface 97 are directed in the same way and are arranged at a distance from one another and from the other six main surfaces 11, 12, 21, 22, 31, 32. The eight main surfaces 11, 12, 21, 22, 31, 32, 96, 97 are in particular arranged parallel to one another within the scope of conventional tolerances.

In this embodiment, the heating layer 70 is encapsulated by arranging the heating layer 70 between the third pane element 30 and the fourth pane element 95.

Alternatively, a laminated safety glass is used for the light extraction. In this case, the third pane element 30 is tinted and a white glass is used as the fourth pane element 95, which is used as a light guide element 35. The heating layer 70 is located between the third pane element 30 and the fourth pane element 95. In addition, low-E layers and/or reflective IR layers are likewise applied in a suitable way in this exemplary embodiment.

The efficiency of the illumination of the vehicle interior is synergically improved by the combination of the pane gap 90 and the light guide element 35.

For the sake of clarity, the size proportions of the individual components do not correspond to the actual size proportions of the arrangement 1.

### LIST OF REFERENCE SIGNS

1 arrangement
10 first pane element
11 first main surface
12 second main surface
20 second pane element
21 third main surface
22 fourth main surface
30 third pane element
31 fifth main surface
32 sixth main surface
35 light guide element
40 metal layer
50 plastic layer
60 switchable film, shading device
65 roller blind apparatus, shading device
70 heating layer
80 light source
85 light beam
90 pane gap
95 fourth pane element
96 seventh main surface
97 eighth main surface
100 vehicle
101 vehicle opening
102 closure element
103 vehicle roof
104 cover
105 roof opening
106 windshield
107 rear window
108 side window
109 vehicle longitudinal direction

1. An arrangement for a vehicle, having
a first pane element, which has a first main surface and has a second main surface that lies opposite the first main surface along a stack direction,
a second pane element, which has a third main surface and has a fourth main surface that lies opposite the third main surface along the stack direction, the second pane element being coupled with the first pane element,
a third pane element, which has a fifth main surface and has a sixth main surface that lies opposite the fifth main surface along the stack direction, a pane gap being arranged between the second pane element and the third pane element, and the third pane element being thermally decoupled from the second pane element,
a heating layer, which is coupled with the third pane element and which is configured to increase the temperature in the vehicle interior.

2. The arrangement according to claim 1, wherein a metal layer is applied on the fourth main surface of the second pane element.

3. The arrangement according to claim 1, wherein a shading device, which is configured to darken the vehicle interior, is arranged between the first pane element and the third pane element.

4. The arrangement according to claim 1, wherein the shading device is arranged between the first and second pane elements and comprises a switchable film.

5. The arrangement according to claim 1, wherein the shading device is arranged between the second and third pane elements and comprises a roller blind apparatus.

6. The arrangement according to claim 1, wherein the pane gap is filled with an insulating gas.

7. The arrangement according to claim 1, wherein the pane gap is evacuated.

8. The arrangement according to claim 1, wherein the heating layer is formed as a film layer and/or is vapor-deposited.

9. The arrangement according to claim 1, wherein the heating layer is applied on the fifth main surface of the third pane element and/or on the sixth main surface of the third pane element.

10. The arrangement according to claim 1, wherein the third pane element is a plate-shaped light guide element, the light guide element being coupled with a light source, and the light guide element being adapted to guide light fed in by the light source and to provide it for predetermined illumination of the vehicle interior.

11. A vehicle, having:
at least one vehicle opening, and
a closure element, which is configured to close the vehicle opening, the closure element having the arrangement according to claim 1.
